(19) United States
(12) Patent Application Publication
(10) Pub. No.: US 2015/0030197 A1
(43) Pub. Date: Jan. 29, 2015

(54) Audio Accessory with Improved Ear Hook and Low Frequency Acoustic Performance

(71) Applicant: Motorola Mobility LLC, Libertyville, IL (US)

(72) Inventors: Peter M. Pavlov, Duluth, GA (US); Sean N. Davie, Lawrenceville, GA (US); Peng Jiang, Duluth, GA (US); Ryan P. Rye, Lawrenceville, GA (US)

(73) Assignee: Motorola Mobility LLC, Libertyville, IL (US)

(21) Appl. No.: 13/951,161

(22) Filed: Jul. 25, 2013

(51) Int. Cl. H04R 1/10

(52) U.S. Cl. CPC H04R 1/105
USPC 381/381

(57) ABSTRACT

A device (400) includes a device hook receiver (503). The device hook receiver defines a port (707) to an acoustic chamber (1103) disposed within the device. An ear hook (403) includes a device hook (502). The device hook attaches to the device hook receiver and at least partially visibly obscures the port. The device hook also provides separation between an outer surface (1303) of the device hook and the port.

### BACKGROUND

1. Technical Field

This disclosure relates generally to devices, and more particularly to audio devices.

2. Background Art

Headsets, such as wireless audio headsets, are becoming increasingly poplar. Wireless headsets, such as those used to wirelessly communicate with a mobile device traditionally include a frame that houses a loudspeaker that is placed over the user's ear. Optionally, a microphone can extend from the housing toward the user's cheek, jaw or mouth.

Users generally desire such headsets to be “hands free,” which means that the headset should include a mechanism to keep the headset attached to the ear, thereby freeing the user's hands for other tasks. It is important for such mechanisms to securely hold the headset against the ear. Prior art headsets used a headband to hold the headset against the ear. Headbands are cumbersome and unfashionable to use. Other headsets use a “plug” that is wedged into a user's ear. These plugs are uncomfortable to wear. Additionally, individuals have different ear sizes so one plug may not fit all users.

Due to the mechanical drawbacks of these prior art systems, more modern devices employ an ear hook that wraps around the user's ear to keep the headset attached while in use. Unless these ear hooks are uniquely fitted to the individual, acoustic performance of the loudspeaker can be compromised. It would be advantageous to have an improved design that offered improved acoustic performance.

### BRIEF DESCRIPTION OF THE DRAWINGS

FIG. 1 illustrates a user wearing a prior art headset.

FIG. 2 illustrates a prior art headset.

FIG. 3 illustrates an acoustic curve illustrating acoustic performance problems that can arise with prior art headset designs.

FIGS. 4-6 illustrate one explanatory headset configured in accordance with one or more embodiments of the disclosure.

FIG. 7 illustrates an exploded view of one explanatory headset configured in accordance with one or more embodiments of the disclosure.

FIG. 8 illustrates an explanatory ear hook assembly configured in accordance with one or more embodiments of the disclosure.

FIG. 9 illustrates a perspective view of one explanatory headset configured in accordance with one or more embodiments of the disclosure.

FIG. 10 illustrates an explanatory ear hook to device acoustic engagement region configured in accordance with one or more embodiments of the disclosure.

FIG. 11 illustrates a sectional view of one explanatory headset configured in accordance with one or more embodiments of the disclosure.

FIG. 12 illustrates a designed interference occurring in an explanatory ear hook to device acoustic engagement region configured in accordance with one or more embodiments of the disclosure.

FIG. 13 illustrates a sectional view of an explanatory ear hook to device acoustic engagement region configured in accordance with one or more embodiments of the disclosure.

FIG. 14 illustrates a method of manufacturing an explanatory ear hook to device acoustic engagement region configured in accordance with one or more embodiments of the disclosure.

FIG. 15 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to improving audio performance in an audio device. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

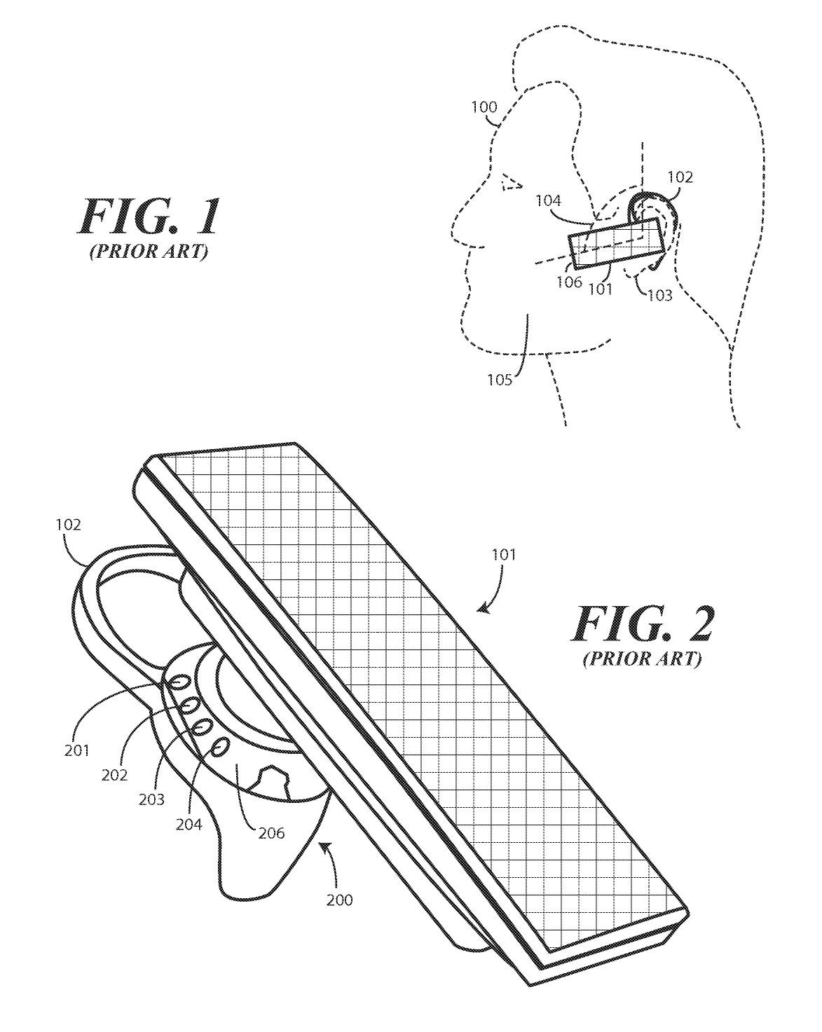

Turning to FIG. 1, illustrated therein is a person 100 wearing a prior art headset 101. The prior art headset 101 includes an ear hook 102 that is fixedly coupled to the headset 101. The ear hook 102 wraps about the person's ear 103. Since the ear hook 102 is fixed relative to the headset 101, the headset 101 is situated at a fixed angle 104 along the person's face 105. The prior art headset 101 includes a loudspeaker positioned over the person's ear 103, and a microphone disposed toward an opposite end 106. The headset 101 can wirelessly communicate with another electronic device, such as a mobile telephone.

Turning now to FIG. 2, the earpiece 200 of the prior art headset 101 can be more readily seen. As mentioned above, the ear hook 102 is fixedly molded into the earpiece 200. A loudspeaker (not shown) is disposed within the earpiece. As shown in FIG. 2, one or more ports 201,202,203,204 are provided in the side of the earpiece 200. The ports 201,202,203,204 extend inwardly to an acoustic chamber. This allows the outer housing 206 of the earpiece 200 to form a ported enclosure for the loudspeaker. Ported enclosures are well known in the art.

A port is a hole in an enclosure disposed about a loudspeaker. The use of a port equalizes pressure on the front and rear sides of the loudspeaker's diaphragm. When the diaphragm moves relative to the housing, the pressure within the enclosure changes. As the diaphragm moves into the housing, internal pressure is increased. The inclusion of a port allows some of this pressure to funnel out of the port. When the diaphragm moves out of the housing, the opposite occurs. The effect is air moving back and forth through the port, which increases the efficiency of the loudspeaker. Increased efficiency is important in headset design because headsets must work on battery power alone. Consequently, conservation of energy is preferred. Low-end frequency response can be increased through the use of ports without requiring additional amplification.

There are inherent problems with the design of the prior art headset 101. To begin, the ports 201,202,203,204 are unsightly. Second, the ports 201,202,203,204 are exposed, thereby permitting liquids, fingers, or other objects to occlude the ports 201,202,203,204. When the ports are occluded, any efficiency gain is lost. When amplification of the headset is tuned with the expectation that the ports 201,202,203,204 will provide additional low frequency response, occlusion of the ports 201,202,203,204 may result in the person (100) not being able to sufficiently hear audio produced by the loudspeaker.

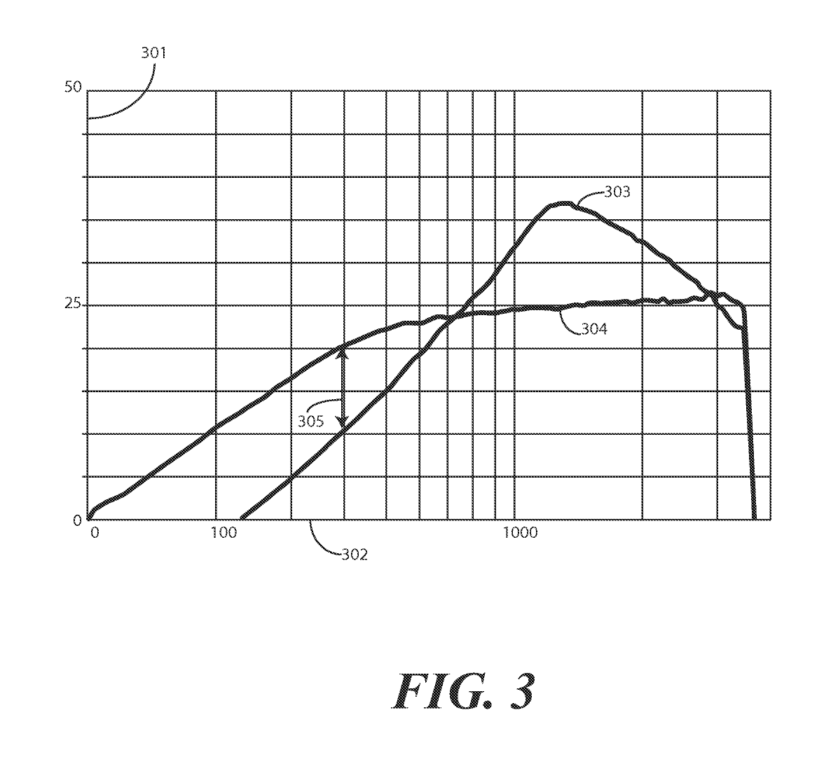

Turning to FIG. 3, the inventors performed experimental testing to demonstrate just how badly the low frequency response can be affected when ports of one prior art headset are occluded. The vertical axis 301 is sound pressure level in decibels relative to 1 Pascal/Volt. The horizontal axis 302 is a logarithmic plot of frequency. Plot 303 illustrates the sound field strength of a prior art headset when its ports are occluded. Plot 304 illustrates the sound field strength of the prior art headset when the ports are open. As shown, at 400 Hz the difference in sound field strength can be as much as 10 dB Pa/V. Compensating for this loss due to port occlusion would require an amplification increase by a factor of more than three, which is generally not possible in a headset.

Embodiments of the disclosure provide a solution to this problem via an improved ear hook and receiver. In one embodiment, a device, which can be a wireless headset, includes a device hook receiver. In one embodiment, the device hook receiver has a concave surface. The concave surface can be axially symmetrical in one embodiment.

In one embodiment, at least one port for a loudspeaker's enclosure is disposed along the device hook receiver. A complementary ear hook then includes a device hook to attach to the device hook receiver. The device hook at least partially wraps about the device hook receiver and the port to at least partially visibly obscure the port without occluding the port. In one or more embodiments, the device hook is designed such that when it wraps about the waist of the device hook receiver, the port always remains at least partially open.

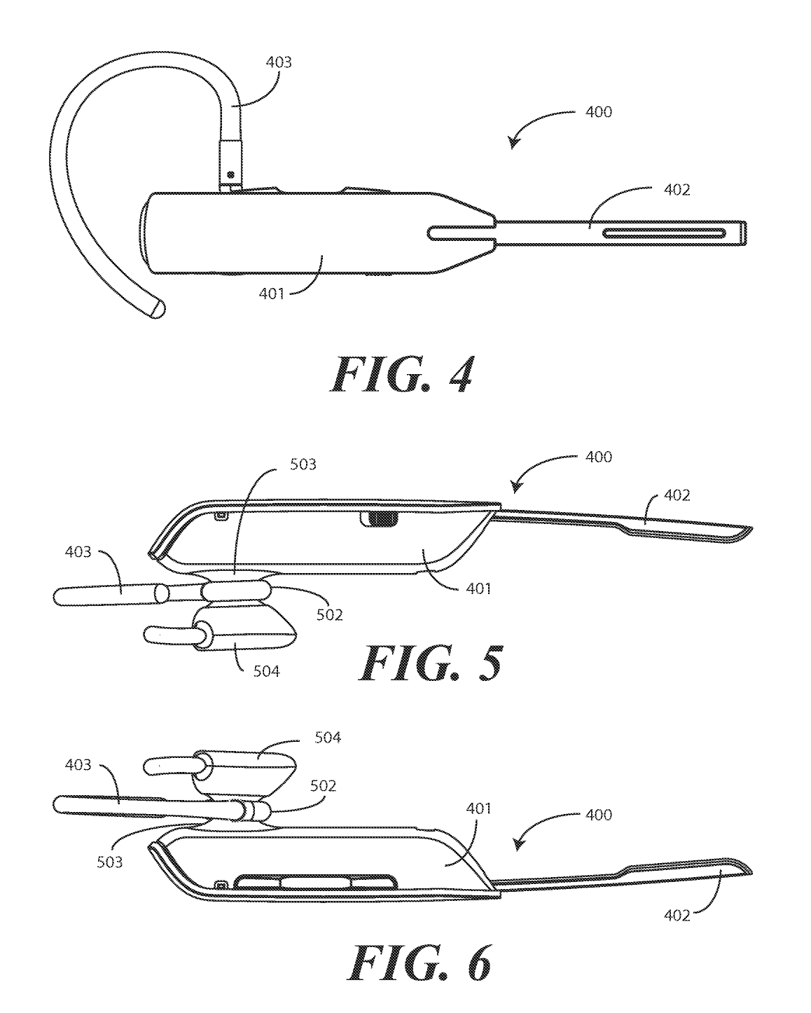

Turning now to FIGS. 4-6, illustrated therein is one embodiment of a device 400 configured in accordance with one or more embodiments of the disclosure. The explanatory device 400 is configured as a wireless headset for an electronic device, such as a portable telephone, for ease of illustration. However, it will be clear to those of ordinary skill in the art having the benefit of this disclosure that the device 400 could be configured in other ways as well. For example, in another embodiment the device 400 could be configured as a wireless listening device for a multimedia player, and so forth.

The device 400 includes a housing 401 having electronic circuitry, energy storage devices such as batteries, and other electronics disposed therein. A boom 402 extends from the housing 401 in this illustrative embodiment. In one or more embodiments, the boom 402 can fold 501 toward the housing 401 for compact storage when not in use.

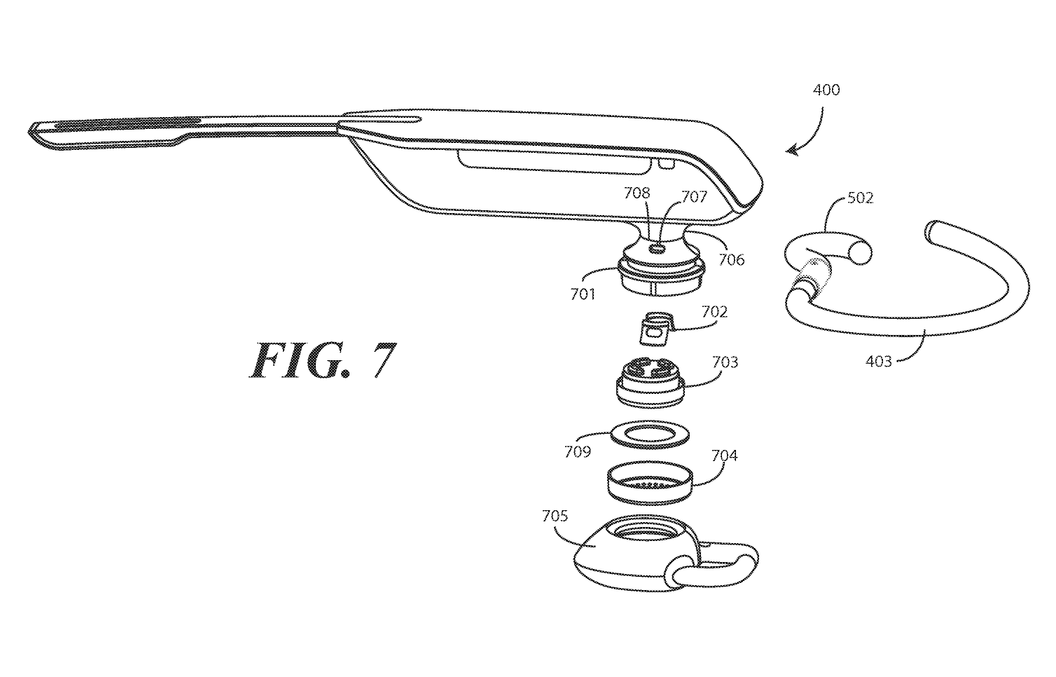

An ear hook 403 extends from a device hook 502. The device hook 502 is coupled to a device hook receiver 503. In this illustrative embodiment, the device hook receiver 503 is disposed between an earpiece 504 and the housing 401. As will be shown in more detail below with reference to FIGS. 7-12, in one or more embodiments the device hook receiver 503 includes one or more ports. Specifically, a concave outer surface of the device hook receiver 503 defines one or more ports to an acoustic chamber disposed within the device 400 adjacent to a loudspeaker (not shown in FIGS. 4-6). In one or more embodiments, the device hook 502 attaches to the device hook receiver 503 to at least partially visibly obscure the port while not occluding the port. Said differently, the device hook 502 partially visibly obscures the port while providing separation between the outer surface of the device hook 502 and the port. In so doing, the device hook 502 serves as a mechanical barrier for the port that prevents fingers and other objects from occluding the port. The visible obscuration is apparent in FIGS. 4-6 in that no port can be seen. The separation between the outer surface of the device hook 502 and the port will be illustrated in more detail with reference to FIGS. 7-12.

Turning to FIG. 7, illustrated therein is an exploded view of the device 400. The earpiece 504 comprises a loudspeaker housing 701, a spacer 702, a loudspeaker 703, a grille 704, and an earpiece cover 705. The loudspeaker housing 701 defines an acoustic chamber therein for the loudspeaker 703. In one embodiment, the acoustic chamber is disposed behind (above in the view of FIG. 7) the loudspeaker 703. The spacer 702 can be used to ensure that the acoustic chamber is at least a minimum predetermined volume in one or more embodiments.

To assemble the earpiece 504, the spacer 702 and loudspeaker 703 are inserted into the loudspeaker housing 701 so that the acoustic chamber is behind and adjacent to the loudspeaker 703. An optional gasket 709 can be placed against the loudspeaker 703 to prevent vibration. The grille 704 is then attached to the loudspeaker housing 701, with the apertures of the grille defining an acoustic output of the device 400. The earpiece cover 705 can then be attached to the loudspeaker housing 701.

As shown in FIG. 7, the device hook receiver 503 includes a concave surface 706. One or more ports 707 to the acoustic chamber are disposed along the concave surface 706. The ear hook 403 is detached from the device 400 so that the device hook 502 can be seen. The device hook 502 is to attach to the device 400 by at least partially wrapping about a waist 708 of the concave surface 706 of the device hook receiver 503. As will be shown below, the device hook 502 is to attach to the device hook receiver 503 and to wrap about the port 707 without occluding the port 707 in one or more embodiments.

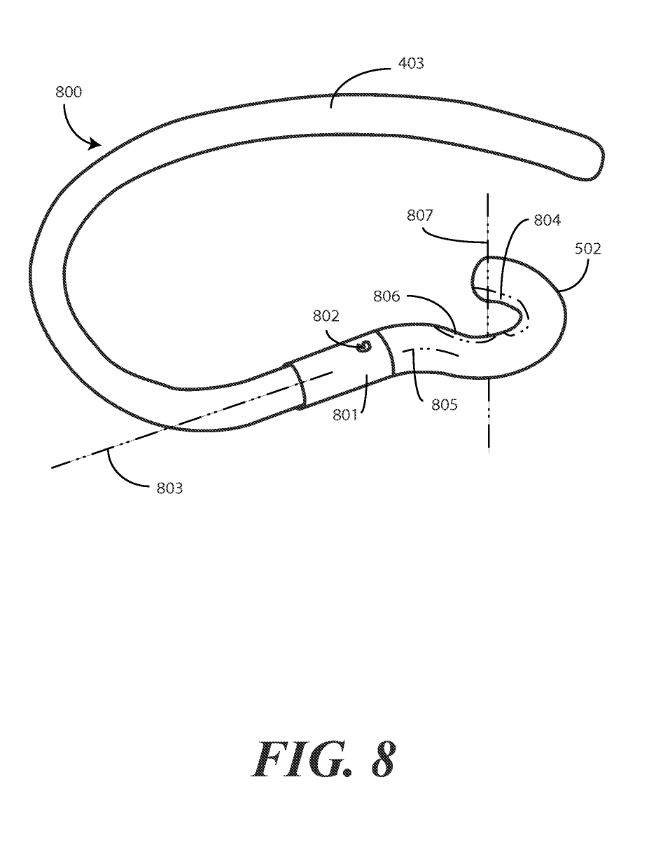

Turning now to FIG. 8, illustrated therein is a more close-up view of the ear hook 403 and device hook 502. In the illustrative embodiment of FIG. 8, the ear hook assembly 800 includes only three components: the ear hook 403, the device hook 502, and a retention sleeve 801. An engagement between the ear hook 403 and the device hook 502 can optionally be facilitated by a device hook engagement component and an ear hook engagement component as described in commonly assigned, U.S. Pat. No. ______, filed concurrently herewith, entitled, “Three-Piece Device Ear Hook,” Attorney Docket No. CS41404, which is incorporated herein by reference for all purposes.

In one embodiment, the device hook 502 is manufactured from a rigid plastic material while the ear hook 403 is manufactured from a pliant material. For example, the device hook 502 can be manufactured from nylon, styrene, ABS, polycarbonate, or polycarbonate-ABS, PMMA, PVC, or other polyamide-based thermoplastics in one embodiment. To be pliant about a user's ear and to allow the device hook engagement component to engage the ear hook engagement component, the ear hook 403 can be manufactured from nylon or other polyamide-type thermoplastics like those listed above with reference to the device hook 502. In one embodiment, the retention sleeve 801 is manufactured from a metal such as stainless steel.

In this illustrative embodiment, the retention sleeve 801 includes at least one protuberance 802 that extends into the retention sleeve 801 toward an engagement axis 803 of the ear hook assembly 800. The ear hook engagement component can include at least two retention sleeve friction engagement components. The retention sleeve friction engagement components can be radially separated by a cantilevered protuberance engagement component. In one embodiment the cantilevered protuberance engagement component includes a distal end to retain the device hook engagement component and the ear hook engagement component together when the retention sleeve 801 is placed over both the device hook engagement component and the ear hook engagement component. This retention can be performed without any additional parts in one embodiment. Said differently, the three parts shown in FIG. 8 are all that is required to retain the ear hook assembly 800 together. Once this is complete, an electronic device, e.g., device (400) can be coupled to the device hook 502 to form an electronic device assembly.

In one embodiment, the device hook 502 defines a device hook receiver engagement surface 804 and an ear hook taper portion 805. In one embodiment, the device hook receiver engagement surface 804 passes less than 180 degrees about a central axis 807 defined by the device hook 502. In one embodiment, the ear hook taper portion 805 passes less than 90 degrees about the central axis 807.

When the device hook 502 is wrapped about the device hook receiver (503), in one embodiment only the device hook receiver engagement surface 804 is configured to positively engage the concave surface (706) of the device hook receiver (503). The ear hook taper portion 805 is then to slowly begin to get farther and farther away from the concave surface (706) along an ear hook bend 806.

The ear hook assembly 800 can prevent occlusion of the ports (707) disposed along the concave surface (706) of the device hook receiver (503) in two ways. The first is due to the radius of a cross section of the device hook 502. When this radius is sufficiently less than a radius defining the concavity of the concave surface (706), separation between an outer surface of the device hook 502 and the port (707) will occur when the device hook 502 wraps about the waist (708) of the device hook receiver (503). The second way occlusion is prevented results from the ear hook taper portion 805 moving away from the concave surface (706) of the device hook receiver (503) along the ear hook bend 806.

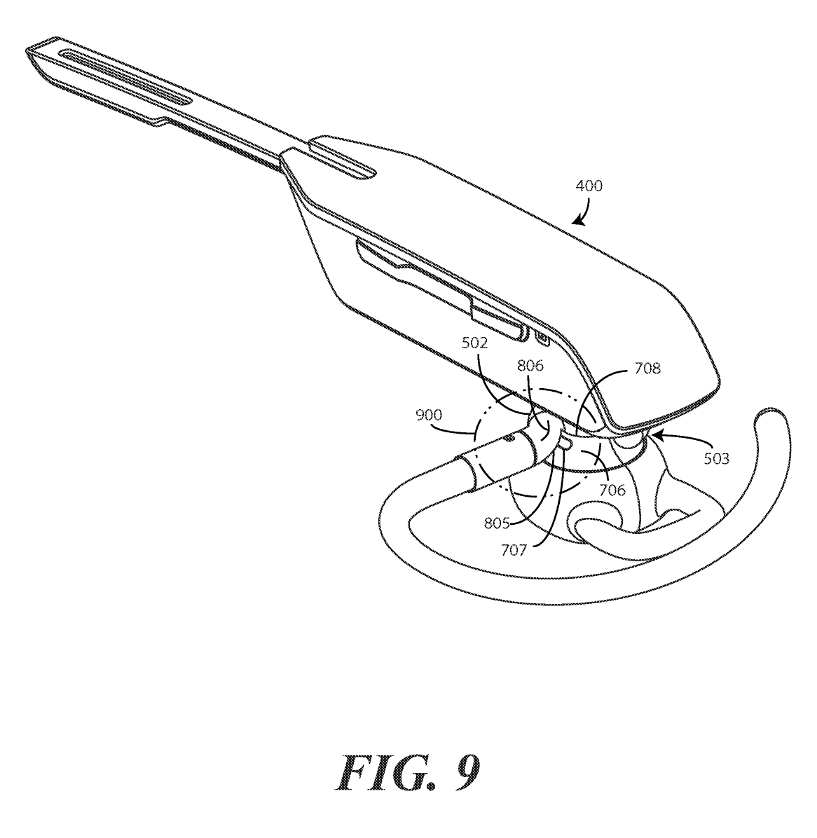

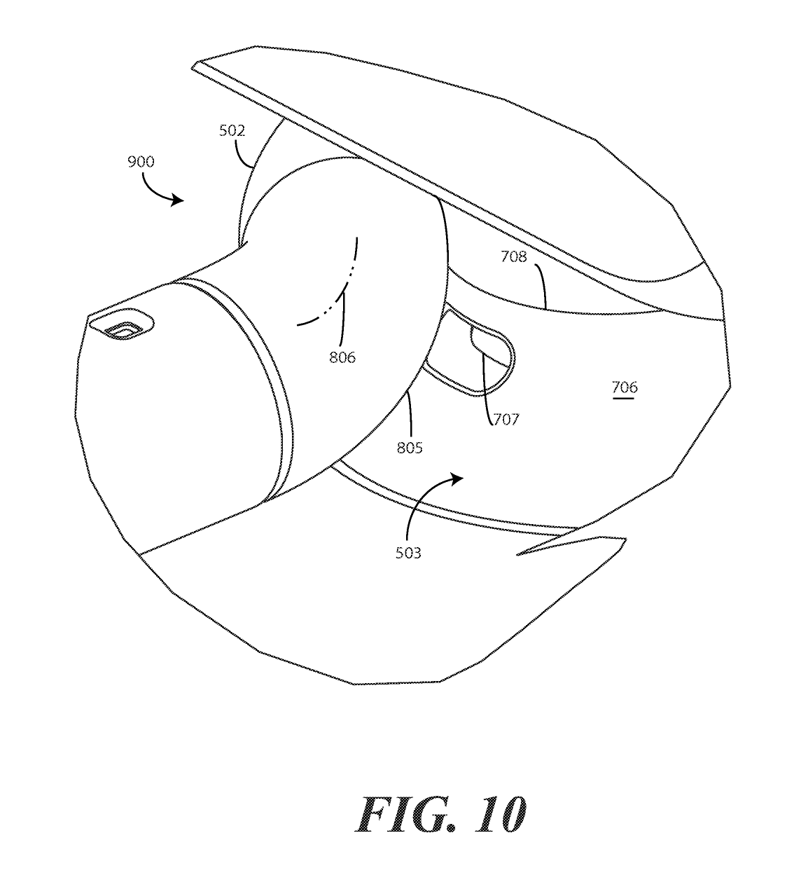

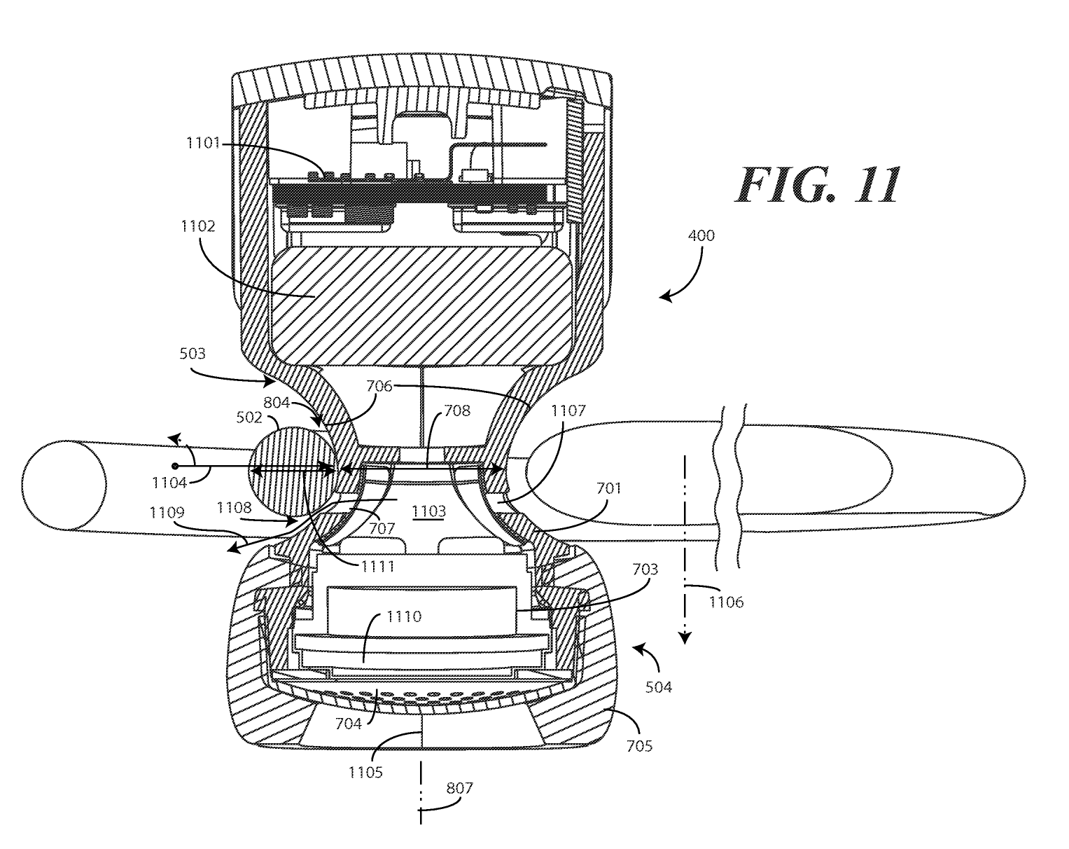

Turning now to FIGS. 9 and 10, the latter way that occlusion is prevented will be examined in more detail initially. FIG. 9 illustrates a perspective view of the device 400 of FIGS. 4-7, while FIG. 10 illustrates a close up view of one portion of the device hook to device hook receiver engagement 900.

As shown in both figures, a port 707 is disposed along the concave surface 706 of the device hook receiver 503. As also shown, the device hook 502 wraps about the waist 708 of the device hook receiver 503 in this illustrative embodiment. In one embodiment, the waist 708 is between five and six millimeters in diameter. In one embodiment, the waist 708 is about 5.6 millimeters in diameter.

Due to the fact that the device hook receiver engagement surface (804) passes less than 180 degrees about a central axis (807), and the fact that the ear hook taper portion 805 passes less than 90 degrees about the central axis (807), when the device hook 502 is wrapped about the device hook receiver 503, only the device hook receiver engagement surface (804) is configured to positively engage the concave surface 706 of the device hook receiver 503. As shown in FIGS. 9 and 10, the ear hook taper portion 805 then moves away from the port 707 as it extends along the ear hook bend 806. Thus, despite the device hook 502 wrapping about the waist 708 of the device hook receiver 503, the inclusion of the ear hook bend 806 prevents at least the ear hook taper portion 805 from occluding the port.

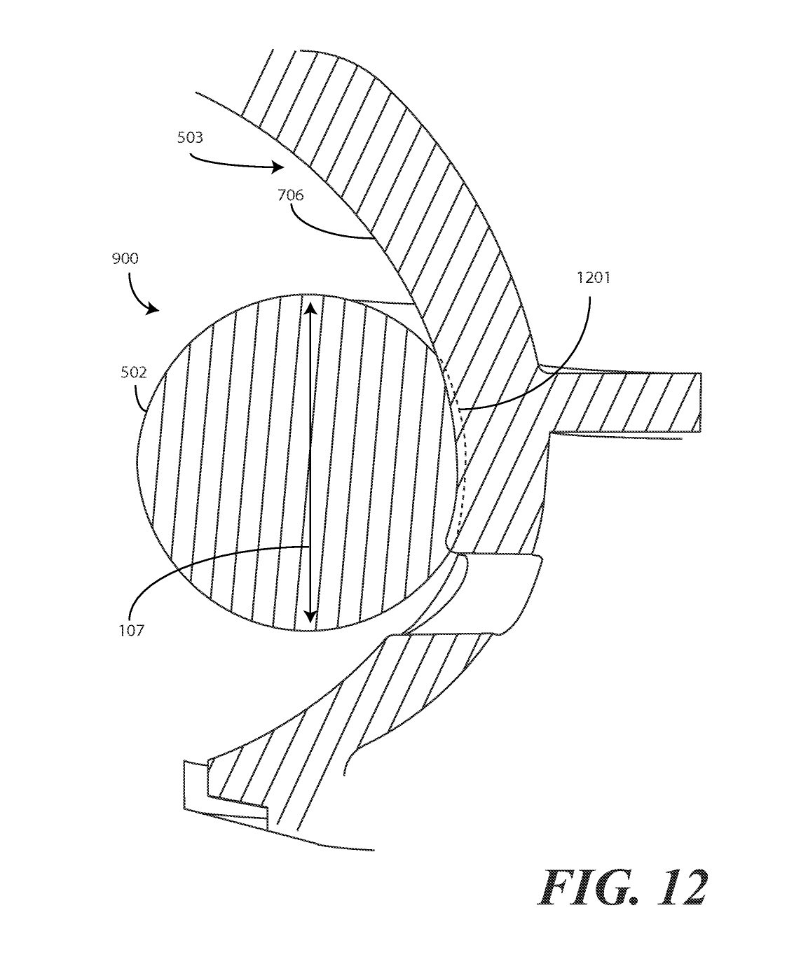

It should be noted that in one or more embodiments the device hook 502 is allowed to pivot about the device hook receiver 503. This conveniently allows the device (400) and boom (402) to be pivoted to any angle a user desires, thereby overcoming the “fixed angle” problem described above with reference to the prior art. As one may anticipate, when the device hook 502 is sufficiently rotated, the device hook receiver engagement surface (804) may pass over and cover the port 707. However, in one or more embodiments, when this occurs occlusion is still prevented. Turning now to FIGS. 11-13, one mechanism by which this can be accomplished will be described in more detail.

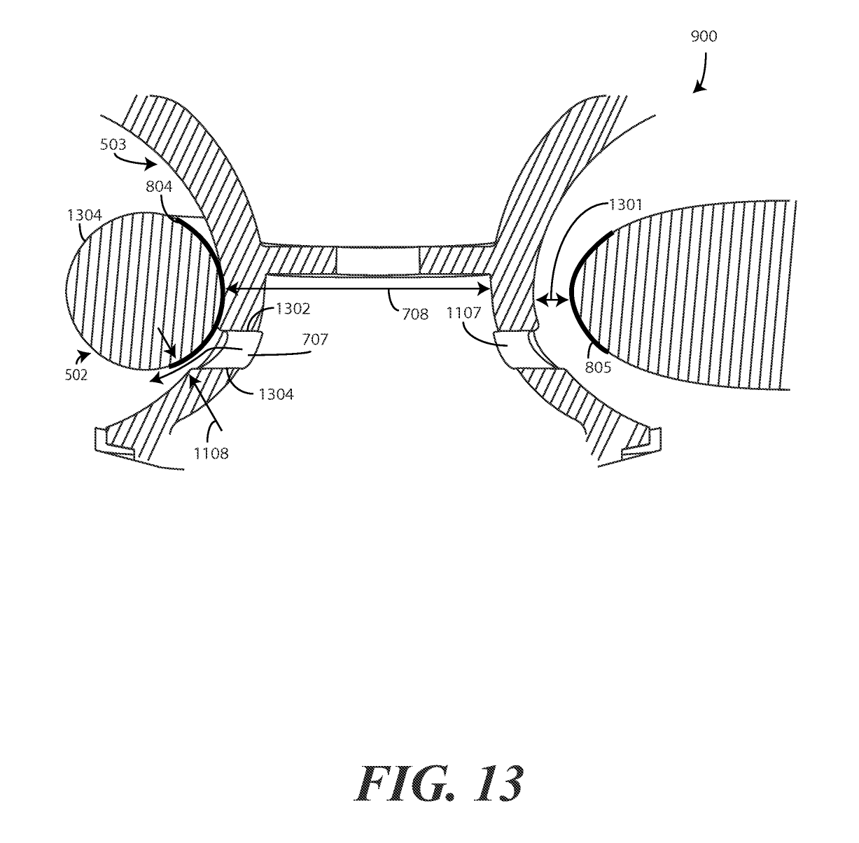

FIG. 11 illustrates a sectional view of the device 400, while FIGS. 12 and 13 illustrate magnified sectional views of the device hook to device hook receiver engagement 900. Beginning with FIG. 11, the device 400 includes electronic circuitry 1101 that is operable with an energy source 1102, shown here as a rechargeable battery. The electronic circuitry 1101 and energy source 1102 can be operable to drive the loudspeaker 703, which is adjacent to an acoustic chamber 1103 defines within the loudspeaker housing 701.

The device hook receiver 503 includes the concave surface 706, which is axially symmetric about a central axis 807 of both the device hook 502 and the earpiece 504 in this illustrative embodiment. In one embodiment, the concave surface 706 is defined by an external radius 1104. In one embodiment, the external radius 1104 is a constant radius. In another embodiment, the external radius 1104 is a parabolic radius having a maximum length at the waist 708 of the device hook receiver 503. Other variations, such as where the external radius 1104 is a cubic or quadric function of its angle of rotation, will be obvious to those of ordinary skill in the art having the benefit of this disclosure.

In one embodiment, the external radius 1104 is a constant radius of between six and seven millimeters. In one embodiment, the external radius 1104 is a constant radius of about 6.5 millimeters. The term “about” is used to indicate a dimension inclusive of manufacturing tolerances. Accordingly, if manufacturing tolerances are +/−0.2 millimeters, both 6.62 and 6.31 millimeters would be “about” 6.5 millimeters. In another embodiment, the external radius 1104 is a parabolic radius having a maximum length of between six and seven millimeters. In one embodiment, the external radius 1104 is a parabolic radius having a maximum length of about 6.5 millimeters.

In this illustrative embodiment, the concave surface 706 of the device hook receiver 503 defines two ports 707,1107 to the acoustic chamber 1103. In one embodiment, the ports 707,1107 are disposed “behind” the loudspeaker 703, meaning that they are disposed on a side of the loudspeaker 703 that is opposite the grille 704 and earpiece cover 705 defining the acoustic output of the device 400. In this illustrative embodiment, the earpiece cover 705 is manufactured from a soft gel.

In one embodiment, the two ports 707,1107 are oriented about 180 degrees from each other about the axis 807. This configuration eases manufacture when housing parts are manufactured with an injection molding process. Specifically, when a parting line 1105 of the overall assembly runs perpendicular to the page of FIG. 11, a tool creating the ports 707,1107 can pull directly to the left and right, respectively, to release from the ports 707,1107 without undercuts. To further ease manufacturability, each of the ports 707,1107 comprises sidewalls that are either substantially perpendicular with the axis 807, or that taper away from the opposing sidewall as they extend distally away from the axis 807. Either configuration simplifies the tool-parting process during manufacture.

As shown in FIG. 11, both ports 707,1107 are disposed on a common side 1106 of the waist 708 of the concave surface 706 of the device hook receiver 503. In one embodiment, each port 707,1107 is disposed at least 0.5 millimeters down the common side 1106 from the waist 708. In one embodiment, each port 707,1107 has a diameter of between 0.6 and 0.8 millimeters. In one embodiment, each port 707,1107 has a diameter of about 0.7 millimeters.

As shown in FIG. 11, the cross section of the device hook 502 in this illustrative embodiment is round, and is defined by a radius 1111. In one embodiment, the cross section of the device hook 502 is substantially circular. As used herein, the term “substantially” takes the same meaning as “about,” in that a “substantially circular” cross section is circular to the extent possible given manufacturing tolerances preventing perfect circularity from being achieved.

In one or more embodiments, the external radius 1104 defining the concave surface 706 of the device hook receiver 503 is greater than the radius 1111 of the cross section of the device hook 502. In one or more embodiments, the external radius 1104 defining the concave surface 706 of the device hook receiver 503 is at least four times greater than the radius 1111 of the cross section of the device hook 502. Illustrating by example, in one embodiment the radius 1111 of the cross section of the device hook 502 is between 1.25 and 1.75 millimeters. In one embodiment, the radius 1111 of the cross section do the device hook 502 is about 1.5 millimeters. Where the external radius 1104 defining the concave surface 706 of the device hook receiver 503 is about 6.5 millimeters, the external radius 1104 would be more than four times greater than radius 1111.

In one or more embodiments, the fact that the external radius 1104 is greater than the radius 1111 of the cross section of the device hook 502 results in separation 1108 being provided between at least a portion of the port 707 that the device hook receiver engagement surface 804 passes over and the device hook receiver engagement surface 804 itself. In one embodiment, the separation 1108 is at least 0.1 millimeters. This separation 1108 means that regardless of how the device hook 502 is rotated about the device hook receiver 503, the port 707 over which the device hook receiver engagement surface 804 passes will never be occluded, thereby allowing air 1109 to move in and out of the port 707 in response to loudspeaker diaphragm 1110 stimulation.

At the same time, the port 707 will be at least partially visibly obscured. This obscuration is due to the fact that the device hook 502 serves as a partial mechanical barrier for the port 707 over which the device hook receiver engagement surface 804 passes. This obscuration results in a more aesthetically pleasing appearance compared to prior art designs. The obscuration also prevents external objects, such as fingers or debris, from occluding the port 707.

In one or more embodiments, the separation 1108 between the device hook receiver engagement surface 804 of the device hook 502 and the port 707 over which the device hook receiver engagement surface 804 passes is further enhanced by way of an intentional interference dimension. Turning now to FIGS. 12-13, this will be explained in more detail.

As noted above, in one embodiment the external radius (1104) defining the concave surface 706 of the device hook receiver 503 is greater than the radius 1111 of the cross section of the device hook 502. Where the external radius (1104) is non-linear, i.e., changes radially, the difference in radii and the fact that the external radius (1104) changes while the radius 1111 of the cross section of the device hook 502 is constant establishes an intentional interference dimension 1201. The intentional interference dimension 1201 is shown in FIG. 12 for illustrative purposes. However, as shown in FIG. 13, the fact that both the device hook 502 and the device hook receiver 503 are solid devices means that the interference dimension (1201) guarantees that the separation 1108 will be established between the port 707 over which the device hook receiver engagement surface 804 passes and the device hook receiver engagement surface 804 itself, which forms an external surface of the device hook in this illustrative embodiment. On the opposite side, the separation 1301 between the hook taper portion 805 of the device hook 502 and the other port 1107 can clearly be seen. In this illustrative embodiment, the separation 1301 between the hook taper portion 805 of the device hook 502 and the other port 1107 is greater than the separation 1108 established between the port 707 over which the device hook receiver engagement surface 804 passes and the device hook receiver engagement surface 804.

In one embodiment, the amount of separation 1108 changes moving away from the waist 708 of the device hook receiver 503. In this illustrative embodiment, the amount of separation 1108 increases moving farther from the waist 708 due to the convex outer surface 1303 of the device hook 502. Illustrating by example, port 707 has two sidewalls 1302,1303. Sidewall 1304 is farther from the waist 708 than is sidewall 1302. Since the outer surface 1304 of the device hook 502 is convex, the separation between the port 707 and the device hook 502 is greater at the second sidewall 1304 than at the first sidewall 1302 in this illustrative embodiment.

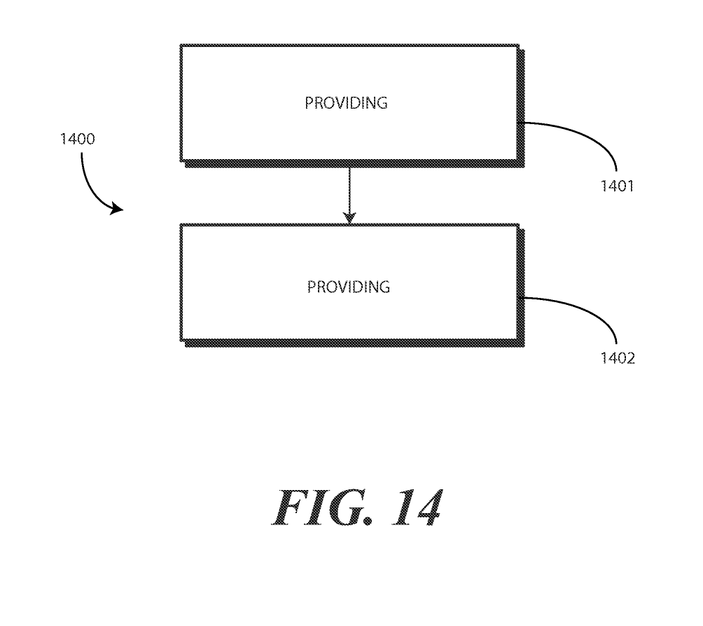

Turning now to FIG. 14, illustrated therein is a method 1400 of manufacturing a device, such as device (400) described above. At step 1401, the method 1400 provides a device having a device hook receiver defining at least one port for a loudspeaker disposed within the device. In one embodiment, step 1401 includes creating a concave surface along the device hook receiver having a first radius. In one embodiment, step 1401 includes disposing one or more ports along the concave surface that will be collocated with a device hook configured to attach to the device hook receiver by wrapping around the concave surface.

At step 1402, an ear hook comprising a device hook to attach to the device hook receiver is provided. In one embodiment, the device hook has a round cross section of a second radius that is less than the radius of step 1401. In one embodiment, step 1402 comprises intentionally designing in a mechanical interference dimension or element to ensure that, despite the fact that the device hook and the ports are collocated, the device hook may pass over the port when wrapping about the port and the concave surface without occluding the port.

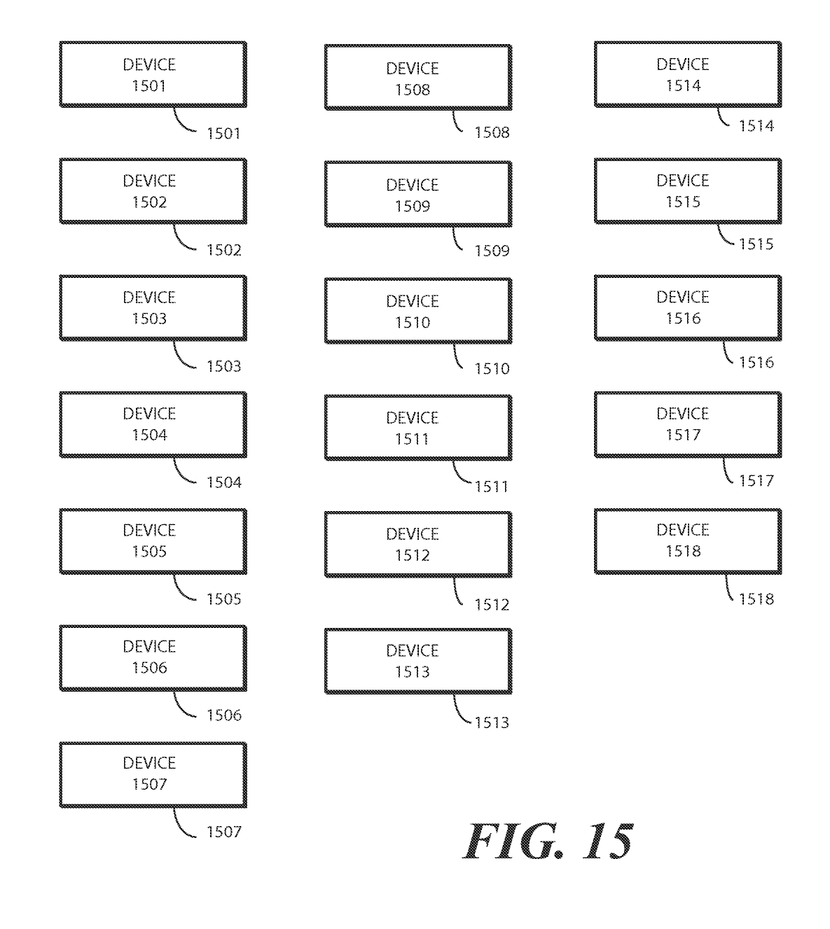

Turning now to FIG. 15, illustrated therein are various embodiments of the disclosure. At 1501, a device comprises a device hook receiver. At 1501, the device hook receiver comprises a concave surface defined by a first radius. At 1501, the device comprises a loudspeaker disposed adjacent to an acoustic chamber of the device. At 1501, the device comprises a port to the acoustic chamber disposed along the concave surface.

At 1501, a device hook extending from an ear hook is to attach to the device by at least partially wrapping about a waist of the concave surface. At 1501, the cross section of the device hook is defined by a second radius. At 1501, the first radius greater than the second radius to provide separation between an outer surface of the device hook and the device hook receiver along the port. At 1501, a mechanical interference dimension can be intentionally created between the device hook and the concave surface to ensure that the device hook does not occlude the port despite the fact that the device hook and the port are collocated on the device hook receiver.

At 1502, the concave surface of 1501 is axially symmetrical. At 1503, the device of 1501 further comprises another port to the acoustic chamber. At 1504, the port and another port of 1503 are disposed about 180 degrees about an axis of the device hook receiver. At 1505, the port and another port of 1503 are both disposed on a common side of the waist.

At 1506, the port of 1501 is disposed at least 0.5 millimeters from the waist. At 1507, the port of 1501 is 0.6 and 0.8 millimeters in diameter. At 1508, the port of 1501 is disposed behind the loudspeaker. At 1509, the first radius of 1501 is at least four times greater than the second radius of 1501.

At 1510, the device hook of 1501 is to at least partially obscure visibility of the port when attached to the device. At 1511, the device of 1501 further comprises an ear hook extending distally from the device hook. At 1512, the port of 1501 comprising sidewalls substantially perpendicular with an axis of the device hook receiver. At 1513, the cross section of 1501 is substantially circular.

At 1514, the separation of 1501 is at least 0.1 millimeters. At 1515, the port of 1501 has a first sidewall and a second sidewall, the first sidewall closer to the waist, the separation greater at the second sidewall than at the first sidewall. At 1516, the device of 1501 comprises a wireless headset.

At 1517, a device comprises an ear hook. 1517, the ear hook comprises a device hook. At 1517, the device comprises a device hook receiver defining a port to an acoustic chamber disposed within the device. At 1517, the device hook is to attach to the device hook receiver to at least partially visibly obscure the port. At 1517, the device hook is to provide separation between an outer surface of the device hook and the port. At 1518, the device hook of 1517 defines a mechanical barrier for the port.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A device, comprising:
a device hook receiver comprising a concave surface defined by a first radius;
a loudspeaker adjacent to an acoustic chamber of the device; and
a port to the acoustic chamber disposed along the concave surface; and
a device hook to attach to the device by at least partially wrapping about a waist of the concave surface, a cross section of the device hook defined by a second radius;
the first radius greater than the second radius to provide separation between an outer surface of the device hook and the device hook receiver along the port.

2. The device of claim 1, the concave surface axially symmetrical.

3. The device of claim 1, the device comprising another port to the acoustic chamber.

4. The device of claim 3, the port and the another port disposed about 180 degrees about an axis of the device hook receiver.

5. The device of claim 3, the port and the another port both disposed on a common side of the waist.

6. The device of claim 1, the port at least 0.5 millimeters from the waist.

7. The device of claim 1, the port between 0.6 and 0.8 millimeters in diameter.

8. The device of claim 1, the port disposed behind the loudspeaker.

9. The device of claim 1, the first radius at least four times greater than the second radius.

10. The device of claim 1, the device hook to at least partially obscure visibility of the port when attached to the device.

11. The device of claim 1, further comprising an ear hook extending distally from the device hook.

12. The device of claim 1, the port comprising sidewalls substantially perpendicular with an axis of the device hook receiver.

13. The device of claim 1, the cross section substantially circular.

14. The device of claim 1, the separation at least 0.1 millimeters.

15. The device of claim 1, the port having a first sidewall and a second sidewall, the first sidewall closer to the waist, the separation greater at the second sidewall than at the first sidewall.

16. The device of claim 1, the device comprising a wireless headset.

17. A device, comprising:
an ear hook comprising a device hook; and
a device hook receiver defining a port to an acoustic chamber disposed within the device;
the device hook to attach to the device hook receiver to:
at least partially visibly obscure the port; and
provide separation between an outer surface of the device hook and the port.

18. The device of claim 17, the device hook defining a mechanical barrier for the port.

19. A method of manufacturing a device, comprising:
providing the device, the device having a device hook receiver defining at least one port for a loudspeaker disposed within the device; and
providing an ear hook comprising a device hook to attach to the device hook receiver and to wrap about the at least one port without occluding the at least one port.

20. The method of claim 19, further comprising:
creating a concave surface along the device hook receiver having a first radius; and
causing the device hook to have a round cross section of a second radius;
the first radius greater than the second radius.
